(19) United States
(12) Patent Application Publication
(10) Pub. No.: US 2020/0163745 A1
(43) Pub. Date: May 28, 2020

(54) PROSTHETIC TOOTH FOR A DENTURE AND DENTURE CONTAINING SAME

(71) Applicant: RIGO DENTAL TECHNOLOGIES LLC, Passaic, NJ (US)

(72) Inventor: Rigoberto Lopez, Passaic, NJ (US)

(21) Appl. No.: 16/632,255

(22) PCT Filed: Jul. 19, 2017
(86) PCT No.: PCT/US17/42804

§ 371 Date: Jan. 17, 2020

(51) Int. Cl. A61C 13/08; A61C 13/07

(52) U.S. Cl. CPC A61C 13/081; A61C 13/082; A61C 13/0025

(57) ABSTRACT

A prosthetic tooth includes an artificial tooth body and a liner at least partly coupled to the tooth body. The liner includes an elastically deformable material that will at least allow the tooth body to move from an unloaded position under a load, and cause the tooth body to move back towards the unloaded position when the load is reduced. Dentures (full and partial) containing one or more of the described prosthetic teeth, and associated methods of making a prosthetic tooth and a denture are also disclosed.

### FIELD OF THE INVENTION

This disclosure relates generally to dental prosthetics and, more particularly, to prosthetic teeth for dentures, and to removable overdentures and rigid partial dentures.

### CROSS-REFERENCE TO RELATED APPLICATION

This application is the U.S. national stage of PCT international application PCT/US17/42804, also titled “PROSTHETIC TOOTH FOR A DENTURE AND DENTURE CONTAINING SAME” and filed Jul. 19, 2017, which is hereby incorporated by reference in its entirety.

### BACKGROUND

With normal teeth, the periodontal ligament between a tooth and the bone socket primarily serves a supportive function, by attaching the root cementum of the tooth to the surrounding alveolar bone proper. However, another function of the periodontal ligament is to serve as a form of shock-absorber that provides resistance to biting forces and allows the teeth to effectively “bounce” and move in their sockets to prevent breaking and reduce the forces that are applied to the bone tissue of the jaw and/or skull.

Traditional (i.e., conventional) dentures rely upon artificial teeth rigidly embedded in a surrounding form, currently typically acrylic, to replace missing teeth of a patient. The acrylic form is molded to match, and in use rests on top of, the underlying gum tissue in the patient's mouth. However, traditional dentures, by their very nature, do not allow the patient to apply full biting force and can easily be dislodged, even when a denture adhesive is used.

Implants are dental prosthetics wherein a post is rigidly anchored into the bone of the jaw or skull and an artificial tooth is affixed to the post. As such, due to the rigid anchoring, the forces resulting from biting and chewing are transferred directly to bone tissue. This can cause problems ranging from headaches and other discomfort, due to the un-cushioned impact between the implant tooth and the opposing tooth, to bone degradation/resorption and pocketing, due to non-axial components of forces applied to the implant. The rigidity can also cause problems for any opposing teeth, due to the non-axial forces, if the implant(s) and opposing teeth are not properly aligned.

Implant-supported overdentures are a hybrid form of the foregoing that are used when multiple teeth must be replaced. These overdentures are designed to removably attach to an implant bar that is rigidly affixed to the bone tissue of the jaw or skull. As such, they provide a superior level of retention, function and quality of life compared to traditional dentures. However, removable overdentures can cause problems similar to those incurred with implants, since biting and chewing forces are likewise transmitted directly to the underlying bone tissue by virtue of their rigid attachment to the denture bar.

A rigid partial denture consists of a metal supporting framework combined with tissue colored acrylic and artificial replacement teeth, and are used when one or more natural teeth remain in the upper or lower jaw. Rigid partial dentures can be (i) tooth supported, (ii) tooth and tissue supported, (iii) tooth and implant supported, or (iv) implant and tissue supported. Rigid partial dentures can cause similar problems discussed above because, in the case where they are supported by normal teeth (in whole or part), they can impart a torque force on the tooth/teeth providing the support. In the case where they are supported, in whole or part, by one or more implants, they can cause localized problems equivalent to those of a removable overdenture.

### SUMMARY

I have devised an improved prosthetic tooth for use in a denture system, and dentures containing one or more such prosthetic teeth, that will more readily absorb axial and non-axial forces that can occur during normal biting and chewing and, therefore, reduce the problems associated with conventional overdentures and partial dentures.

One aspect of this disclosure simply involves a prosthetic tooth made up of an artificial tooth body and a deformable liner coupled to a portion of the artificial tooth body.

An additional aspect of this disclosure simply involves a denture containing at least one prosthetic tooth made up of an artificial tooth body and a deformable liner coupled to a portion of the artificial tooth body, with part of the deformable liner being within a supporting body of the denture such that the artificial tooth body is only coupled to the supporting body of the denture by the deformable liner.

A further aspect of this disclosure involves a method of making a prosthetic tooth. The method involves coupling a deformable liner to a portion of an artificial tooth body.

A still further aspect of this disclosure involves a method of making a denture. The method involves forming a supporting body of a denture about a deformable liner coupled to an artificial tooth body so that the artificial tooth body is only coupled to the supporting body of the denture by the deformable liner.

Yet a further aspect of this disclosure involves an alternative method of making a denture. The method involves maintaining an artificial tooth body in a spaced relationship with a supporting body for a denture such that the artificial tooth body is positioned where it is to reside in the denture relative to the supporting body and a cavity exists between the artificial tooth body and the supporting body. The method then involves introducing a material into the cavity that will couple the artificial tooth body and the supporting body to each other, while remaining deformable, such that the artificial tooth body can move relative to the supporting body through deformation of the liner due to application of a load that can be applied by a human mouth to the artificial tooth body and return towards an undeformed position when the load is removed.

Another aspect of this disclosure involves a prosthetic tooth including an artificial tooth body having and at least a first portion that replicates a tooth crown of a human tooth, that is one of a molar, a premolar or a cuspid, and a second portion, adjacent the first portion, that corresponds, in location, to a tooth neck. The prosthetic tooth also includes a liner, at least partly coupled to the artificial tooth body, the liner having a first section located on a side of the second portion opposite the first portion, and a second section coupled to at least some of the second portion of the artificial tooth body. The second section has a varied thickness such that the liner is thinner in an area that is closest to the first portion of the artificial tooth body than in an area closer to the first section. The liner includes an elastically deformable material, wherein the first section will compress from an unloaded position, under a first load applied along a tooth long axis of the artificial tooth body, by a first amount that is within a normal in vivo tooth displacement range for a corresponding normal tooth when in situ under the first load along an equivalent normal tooth long axis, and the second section will at least allow the artificial tooth body to shift from the unloaded position, through deformation of at least some of the liner, under a second load, the second load being applied in a direction that causes at least one of: pivoting of the tooth long axis of the artificial tooth body, or translation of the artificial tooth body, perpendicular to the long axis, such that the shift of the artificial tooth body will be by a second amount that is within a normal in vivo tooth shift range for the corresponding normal tooth when in situ under application of the second load. The liner will also cause the artificial tooth body to move back towards the unloaded position when at least one of the first lead or second load is reduced.

A further aspect of this disclosure involves a denture. The denture includes an acrylic supporting body colored so as to create an appearance of human gum tissue, and at least one prosthetic tooth. The prosthetic tooth includes an artificial tooth body having at least a first portion that replicates a tooth crown of a human tooth that is one of a molar, a premolar or a cuspid, and a second portion, adjacent the first portion, that corresponds, in location, to a tooth neck. The prosthetic tooth also includes a liner, substantially within the acrylic supporting body, the liner having a first side and a second side, wherein at least some of the first side is coupled to the artificial tooth body, and at least some of the second side is coupled to the acrylic supporting body, so as to create an appearance of a normal tooth within normal gum tissue, the liner having a first section located on a side of the second portion opposite the first portion, and a second section coupled to at least some of the second portion of the tooth body. The liner includes an elastically deformable material. The first section of the liner will compress from an unloaded position within the acrylic supporting body, under a first load applied along a tooth long axis of the artificial tooth body, by a first amount that is within a normal in vivo tooth displacement range for a corresponding normal tooth in situ under the first load along an equivalent normal tooth long axis. The second section of the liner will allow the tooth body to shift within the acrylic supporting body from the unloaded position, through deformation of at least some of the liner, under a second load, the second load being applied in a direction that causes at least one of: pivoting of the long axis, or translation of the artificial tooth body, perpendicular to the long axis, such that the shift of the tooth body will be by a second amount that is within a normal in vivo tooth shift range for the corresponding normal tooth when in situ under application of the second load. The liner will cause the artificial tooth body to move back towards the unloaded position when at least one of the first lead or second load is reduced.

Still other aspects of this disclosure also involve a denture. The denture includes a supporting body, colored so as to create an appearance of human gum tissue, and a prosthetic tooth, coupled to the supporting body via an elastically deformable liner, located substantially within the supporting body so as to create an appearance of a normal tooth within normal human gum tissue. The liner has a first side and a second side, wherein a first part of the first side of the liner is attached to the prosthetic tooth, and a second part of the second side of the liner is attached to the acrylic supporting body so that the prosthetic tooth is only connected to the supporting body via the liner. The liner geometry and elasticity is such that the liner will compress from an unloaded position within the supporting body, under a first load applied along a tooth long axis of the prosthetic tooth, by a first amount that is greater than zero but less than an upper limit of a normal in vivo tooth displacement range for a corresponding normal tooth in situ, and allow the prosthetic tooth to shift within the supporting body from the unloaded position, through deformation of at least some of the liner, under a second load, the second load being applied in a direction that causes at least one of: pivoting of the long axis, or translation of the prosthetic tooth, perpendicular to the normal tooth long axis, such that the shift of the prosthetic tooth will be by a second amount that is greater than zero but less than an upper limit of a normal in vivo tooth shift range for the corresponding normal tooth when in situ. The liner will also cause the prosthetic tooth to move back towards the unloaded position when at least one of the first lead or second load is reduced.

Additional implementations of my solution involve the first section of the liner being between 0.4 mm and 0.6 mm thick.

Further implementations of my solution involve the second section of the liner being between 0.20 mm and 0.35 mm thick in the area that is closest to the first portion.

Yet other implementations of my solution involve at least one liner affixation feature via which the liner is coupled to the artificial tooth body.

Still other implementations of my solution involve the at least one liner affixation feature including one or more of: a hole, a post, a lug, a prong, a bar, a recess or a protrusion.

Other implementations of my solution involve the liner being coupled to the artificial tooth body by at least one of: a mechanical connection, a chemical connection, or an adhesive material.

Other additional implementations of my solution involve the supporting body defining an artificial gum line on the prosthetic tooth and wherein some of the liner extends outside the supporting body beyond the artificial gum line.

Still further aspects of this disclosure involve methods of making a prosthetic tooth according to a process described herein.

Yet other aspects of this disclosure involve methods of making a denture (full or rigid partial) according to a process described herein.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIGS. 1A-1C illustrate, in simplified form, (prior art) human teeth, in vivo and in situ in human gum and bone tissue;

FIG. 2A illustrates, in simplified form, a set of example, commercially available, artificial/prosthetic prior art teeth having a flat base;

FIG. 2B illustrates, in simplified form, side and bottom views of a set of other example, commercially available, artificial/prosthetic prior art teeth that include a recess or cavity in the base;

FIG. 3 illustrates, in simplified form, a set of example prosthetic teeth bodies constructed according to one aspect of the teachings herein;

FIG. 4 illustrates, in simplified form, a cross section of a portion of a denture containing an artificial tooth body incorporating a liner according to the teachings herein;

FIG. 5 illustrates, in simplified form, the prosthetic tooth of FIG. 4 in situ (i.e., in the denture) before and after being subjected to a force F_{V} directed through the centroid along the longitudinal tooth axis;

FIG. 6 illustrates, in simplified form, the prosthetic tooth of FIG. 4 in situ before and after being subjected to a force F_{H} directed perpendicular to the longitudinal tooth axis;

FIG. 7 illustrates, in simplified form, the prosthetic tooth of FIG. 4 in situ before and after being subjected to a net force F directed at a point that is neither directly along, nor perpendicular to, the longitudinal tooth axis;

FIGS. 8A through 8K illustrate, in simplified form, lingual and bottom views of example prosthetic teeth incorporating one or more example affixation features;

FIG. 9 illustrates, in simplified form. a cross section of a portion of an example denture incorporating an example of a liner affixation feature formed in the supporting body of a denture;

FIGS. 10A through 10C illustrate, in simplified form, some alternative example implementations of my approach that can be used in certain cases;

FIG. 11 is a photograph of an example implementation denture incorporating example variant prosthetic teeth as described herein; and

FIG. 12 is a photograph of the example implementation denture of FIG. 11 in which a section of the supporting body has been removed to make visible part of the respective liners.

### DETAILED DESCRIPTION

My technical solution improves upon current overdenture/denture bar, and rigid partial denture, technology and, implementations thereof provide a solution to one or more aforementioned problems.

As an initial matter, it is to be understood that the following definitions are intended to apply to the foregoing Summary and following description, including the claims, wherever a form of the particular term or phrase is used.

The phrase “normal in vivo tooth displacement range” for a posterior tooth (molar or premolar/bicuspid) is intended to mean a range of between 50 and 80 micrometers and, more particularly, a range of between 56 and 75 micrometers.

The phrase “normal in vivo tooth displacement range” for an anterior tooth (incisor or cuspid) is intended to mean a range of between 90 and 110 micrometers.

The phrase “normal in vivo tooth shift range” for anterior and posterior teeth is intended to mean a range of between 25 and 35 micrometers, and typically about 28 micrometers.

The term “denture” is intended top mean and encompass either or both of a an overdenture that attaches to a denture bar, an implant supported denture, or a rigid partial denture, but the term “denture” is intended to expressly exclude, and not mean or encompass, conventional dentures of a removable type that merely rest on natural gum tissue or are temporarily adhered to the natural gum tissue by denture adhesive.

Finally, the term “affixation feature” is intended to mean any feature, of any shape and type, that can physically aid in forming a connection between a liner as described herein and either or both of the neck portion of an artificial tooth body or a supporting body of a denture.

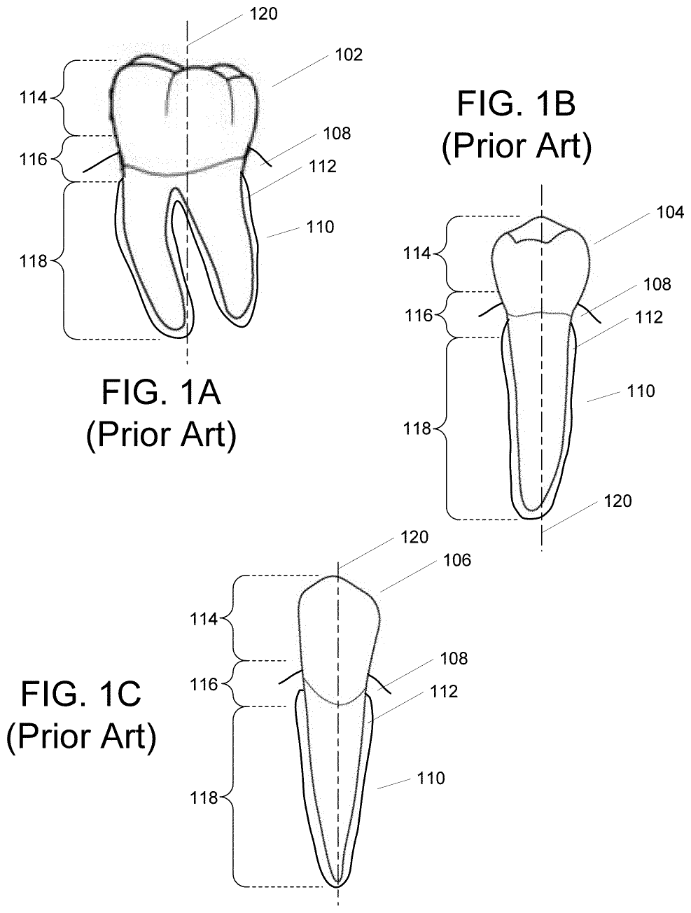

With the foregoing in mind, FIGS. 1A-1C illustrate, in simplified form, (prior art) human teeth, a molar 102, premolar 104 and a cuspid 106, in vivo and in situ in human gum 108 and bone 110 tissue making up the bone socket (not shown). As is known, teeth are conventionally referred to as having a crown 114, a neck 116 below the crown 114, and a root 118, below the neck (with “below,” “down” or “downward” referring to a direction towards the gum 108 and bone tissue 110 making up the particular tooth socket, irrespective of whether the bone tissue is in the lower jaw or upper jaw/skull). As is further known, and noted above, the teeth 102, 104, 106 are connected to the bone tissue 110 by periodontal ligaments 112 and it is the periodontal ligaments 112 that, among other things, allow a tooth to move, pivot and twist relative to the respective bone tissue. More particularly, in response to a force applied to a natural, normal, tooth 102, 104, 106 along its long axis 120 (when in the human mouth), the tooth will displace in a direction along the longitudinal axis 120 by an amount that, at its maximum, is generally within what is considered the normal in vivo tooth displacement range for that tooth (i.e., depending upon whether it is a posterior or anterior tooth). Likewise, in response to a force applied to a natural, normal, tooth 102, 104, 106 perpendicular to its long axis 120 (when in the human mouth), will shift along that direction by an amount that, at its maximum, is generally within what is considered the normal in vivo tooth shift range. Consequently, a force applied at an angle between a perpendicular to the long axis 120 and a direction along the long axis will cause the tooth to pivot and/or twist based upon exactly where the net force is applied, which will be a function of at least its horizontal (i.e., perpendicular to the long axis 120) and vertical (i.e., along the long axis 120) force components.

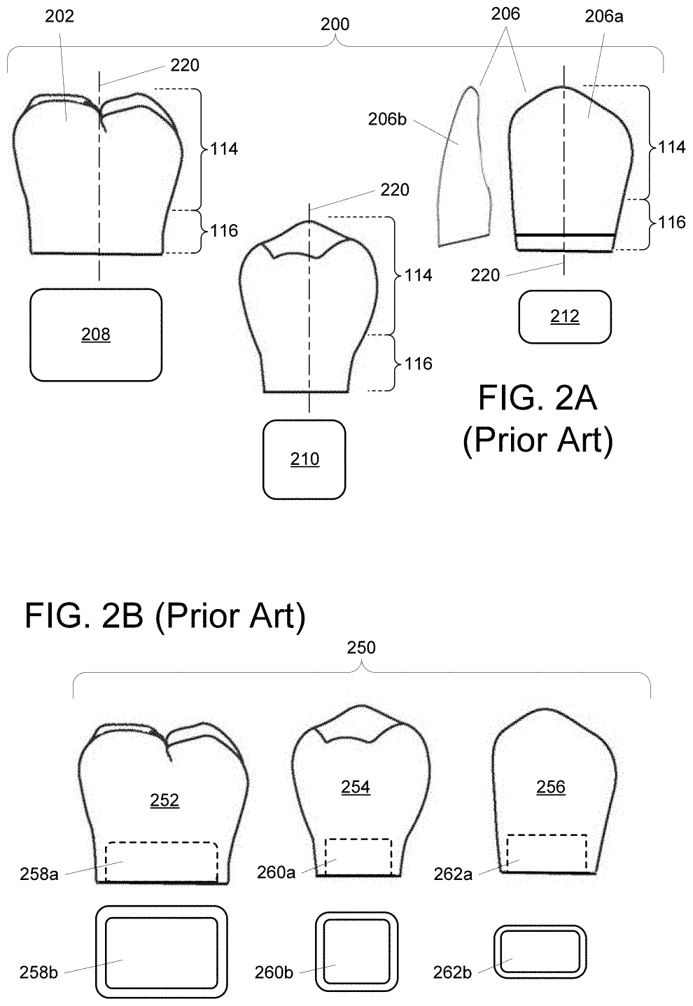

FIG. 2A illustrates, in simplified form, a set 200 of example, commercially available, prior art prosthetic teeth, specifically, an artificial molar 202, an artificial premolar 204 and an artificial cuspid 206 (shown in lingual 206a and side view 206b), that are each designed to replicate the look of their corresponding natural teeth 102, 104, 106. These prosthetic teeth 202, 204, 206 each analogously include a crown 114 and neck 116, but do not include an analog to the root 118 of a natural tooth. Instead, the prosthetic teeth 202, 204, 206 are truncated in some fashion at or near the bottom of the neck 116 portion.

As shown in FIG. 2A, the bottom view of each of the prosthetic teeth 202, 204, 206 include a flat base 208, 210, 212, which, may be perpendicular to the longitudinal axis 220 of the prosthetic tooth 202, 204 (as shown 208, 210) or maybe inclined at some angle (as shown 212).

FIG. 2B illustrates, in simplified form, side and bottom views of a set 250 of other example, commercially available, prior art prosthetic teeth, specifically, an artificial molar 252, an artificial premolar 254 and an artificial cuspid 256, that are similar to those of FIG. 2A except that, instead of having a flat base 208, 210, 212, they each include an inwardly extending recess or cavity 258a, 258b (molar 252), 260a, 260b (premolar 254), and 262a, 262b (cuspid 256). These recesses or cavities 258a, 258b, 260a, 260b, 262a, 262b provide greater surface area for the gum tissue-colored acrylic that will be molded around the prosthetic teeth, or into which the prosthetic teeth will be affixed, to form a denture.

Thus, as was noted above, with conventional overdentures (full and partial), the artificial teeth are rigidly constrained within the (typically) acrylic supporting body that either attaches to a denture bar, one or more natural teeth, or rests on the remaining gum tissue, and therefore, the “shock absorber” function of the periodontal ligaments 112 is lost. In contrast to the foregoing conventional prosthetic teeth and dentures, I have devised a prosthetic tooth for use in a denture that closely replicates the “shock absorber” aspects of the periodontal ligaments and thereby dramatically improves patient comfort and significantly reduces the likelihood of the above-identified problems occurring.

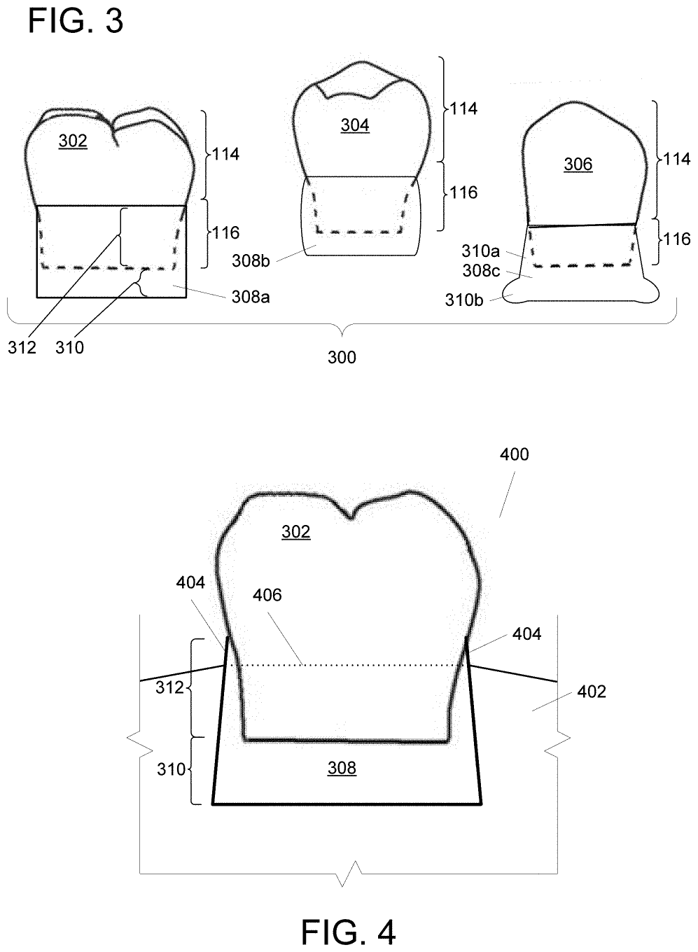

FIG. 3 illustrates, in simplified form, a set 300 of example prosthetic teeth, specifically, an example artificial molar body 302, artificial premolar body 304, and artificial cuspid body 306, constructed according to one aspect of the teachings herein.

As shown, each of the prosthetic teeth include a liner 308 that is, at least partially, coupled to (e.g., surrounding or alongside) at least a portion of the respective tooth neck 116 portions of the prosthetic molar body 302 (308a), prosthetic premolar body 304 (308b), and prosthetic cuspid body 306 (308c). The liner is made of an elastically deformable material that allows it to deform from a normal (i.e., “unloaded”) position under the application of a force to the prosthetic tooth of which it is a part, and to return towards the unloaded position as the force is removed.

Example materials suitable for use as, or as part of, a liner 308 can include, but are not limited to, Moloplast-B (commercially available from Buffalo Dental Manufacturing Co., Inc., 159 Lafayette Dr., PO Box 678, Syosset, N.Y. 11791), Permasoft (commercially available from Perma Labs, PO Box 327, Richfield, Ohio 44286), and Visco-gel (commercially available from DENTSPLY Caulk, 38 West Clarke Avenue, Milford, Del. 19963). Other elastically deformable materials may also be used for the liner provided that they can be coupled, in a manner described herein, to the prosthetic tooth and, for a denture, to the supporting body material.

As shown in FIG. 3, merely for purposes of illustration, the liner 308 can take on any of a myriad of shapes appropriate for the particular denture/patient circumstance. For example, the artificial molar body 302 has a surrounding liner 308a that has a fairly cylindrical shape, whereas the example artificial premolar body 304 has a surrounding liner 308b that has more of a “barrel” shape, and the example artificial cuspid body 306 has a surrounding liner 308c that has an upper portion 310a that is more of a conic shape and a lower portion 310b that flares out from the conic portion. Advantageously, the ability to form different shape liners 308 allows for the liner 308 to conform to the required artificial gum anatomy of a denture while still providing the shock absorber function and, more importantly, can provide a measure of mechanical connection between the liner 308 and supporting body of a denture.

In general, the liner 308 can conceptually be thought of as having two sections 310, 312, one section 310 that lies below at least a part of the prosthetic tooth neck 116 (i.e., on the side of the neck 116 opposite the crown 114) and another section 312 that surrounds, or is alongside, at least part of the prosthetic tooth neck 116.

As can also be seen in this figure, irrespective of the thickness of the part 310 of the liner below the artificial tooth body's neck 116, when the liner 308 is continuous in the longitudinal axis direction, the part 312 of the liner 308 surrounding, or alongside, some part of the neck 116 that is closest to the crown 114 of an artificial tooth body will typically be thinner than the part of the liner 308 surrounding, or alongside, a part of the neck 116 that is farther from the crown 114 of the artificial tooth body.

In general, by way of illustrative example only, for Moloplast-B, the part 310 of the liner 308 below the artificial tooth body's neck 116 will be typically between 0.4 mm and 0.6 mm thick (measured along the longitudinal axis) and the part 312 of liner 308 in the area closest to the crown 114, at the actual (or intended) artificial gum line, will typically be between 0.2 mm and 0.35 mm thick. However, it is to be understood that those thicknesses are merely for purposes of example, the thicknesses being a function of the particular liner material used and its elasticity, so they can vary. Thus, the important point is that the thickness for a given liner material, in a particular location, should ideally be selected to allow a maximum displacement, for the particular posterior or anterior tooth, that is within the respective normal in vivo tooth displacement range and, likewise, allow a maximum shift that is within the normal in vivo tooth shift range.

FIG. 4 illustrates, in simplified form, a cross section of a portion 400 of a denture containing a prosthetic tooth incorporating a liner 308 according to the teachings herein, in this example case, made up of a molar-shaped artificial tooth body 302 that is surrounded by a liner 308 that is at least partially shaped like a conic section.

As shown in FIG. 4, the portion 400 includes a rigid (typically acrylic) supporting body 402 of the denture that would be colored similar to natural human gum tissue, typically, the gum tissue color for the intended recipient patient As can be seen in FIG. 4, the uppermost part 404 of the liner 308 extends above the artificial gum line 406 of the rigid acrylic supporting body 402. This ensures that the prosthetic tooth, in this example, the molar-shaped artificial tooth body 302, can displace, shift and/or pivot by some amount, when a force is applied to it, through deformation of the liner 308 until, at a maximum, either, the liner 308 is compressed to its limit in that area, or the prosthetic tooth impacts the rigid acrylic supporting body 402. It is to be noted here that, in some cases, it may be desirable to remove the uppermost part 404 of the liner 308 for example, that portion above the artificial gum line 406, down to or near the artificial gum line 406, for cosmetic or some other reason. Advantageously, in many cases, doing so will not adversely affect the intended performance of the prosthetic tooth and, in specific cases, may actually enhance the shock absorbing, periodontal ligament-like, performance of the prosthetic tooth by potentially allowing for a greater degree of movement. However, as a further matter, since the intent is to closely replicate the periodontal ligaments' shock absorber function using a liner 308, the removal of the uppermost part 404 of the liner 308 should not typically allow for a shifting movement that would result in an ability of the prosthetic tooth to shift at its maximum, under normal biting or chewing action, beyond a value within the normal in vivo tooth shift range as described herein, absent the need to accommodate patient-specific, unusual, gum and/or jaw anatomy.

With the foregoing in mind, the ability of a prosthetic tooth, constructed according to the teachings herein, to move based upon the presence of the liner 308 will now be described in greater detail.

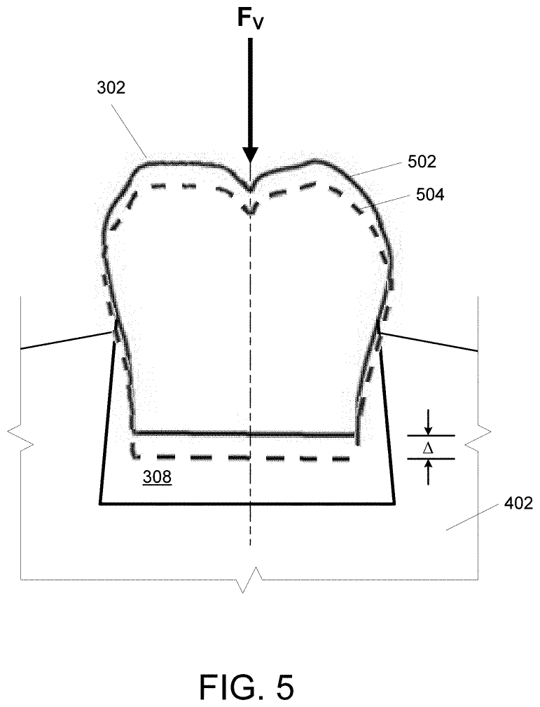

FIG. 5 illustrates, in simplified form, the prosthetic tooth of FIG. 4 in situ (i.e., in a denture) before and after being subjected to a force F_{V} directed through its centroid along the longitudinal tooth axis. As shown, the artificial tooth body 302 has an unloaded position 502 corresponding to that shown in FIG. 4. When the force F_{V} is applied, it causes the liner 308 to compress, which results in a displacement of the tooth downward to a displaced position 504—shown by dashed lines—along the longitudinal axis by an amount (indicated in FIG. 5 by “Δ”) that, at its maximum, should be within the normal in vivo tooth displacement range.

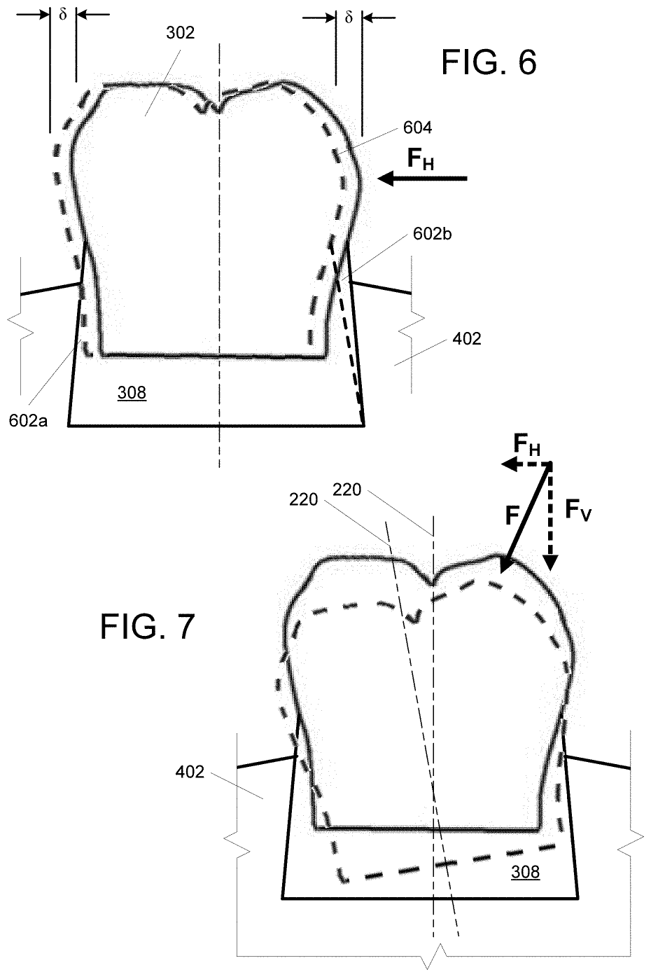

FIG. 6 illustrates, in simplified form, the prosthetic tooth of FIG. 4 in situ before and after being subjected to a force F_{H} directed perpendicular to the longitudinal tooth axis. As shown, when the force F_{H} is applied, it causes part of the liner 308 coupled to the neck of the artificial tooth body 302 to compress 602a on the side of the artificial tooth body 302 opposite the side where the force is applied, and to elongate 602b on the side of the artificial tooth body 302 where the force is applied, which, consequently, results in a horizontal shifting of the artificial tooth body 302 to a shifted position 604—shown by dashed lines—that is perpendicular to the longitudinal axis by an amount (indicated in FIG. 5 by “δ”) that, at its maximum, should be within the normal in vivo tooth shift range.

FIG. 7 illustrates, in simplified form, the prosthetic tooth of FIG. 4 in situ before and after being subjected to a net force F directed at a point that is neither directly along, nor perpendicular to, the longitudinal tooth axis. As a result, as shown, the liner 308 will both compress and elongate in some parts, generally according to the vertical (F_{V}) and horizontal (F_{H}) components of the force (F) applied to the artificial tooth body 302. Note here that the force may also cause pivoting and/or twisting of the artificial tooth body 302, depending upon the location where the net force is applied. Those movements will similarly, automatically, be accommodated by the elasticity of the liner 308, provided that the displacement and shift are within the respective normal in vivo tooth displacement range and normal in vivo tooth shift range for the particular tooth involved.

Depending upon the particular implementation, and materials involved, various examples for forming my prosthetic tooth and a denture (full or partial) containing one or more variants of such prosthetic teeth as described herein will now be described.

In general, prosthetic teeth are made of either acrylic, porcelain, or metal (with a ceramic overlay (typically called a “metal-ceramic reconstruction”)). In contrast, modern denture supporting bodies are typically made of acrylic. Thus, the same approach to coupling a liner as described herein to each cannot necessarily be used.

Advantageously, my approach allows for a liner 308, as described herein, to be attached to a prosthetic tooth through any one or more of: a chemical approach, using an adhesive, or a mechanical approach.

The chemical approach is generally useful for circumstances where both the prosthetic tooth and supporting body are acrylic. With the chemical approach, a curable liner material is deposited between a prosthetic tooth and a cavity formed within the supporting body. The curable liner material is then cured, with the curing process causing the liner material to chemically bond with both the prosthetic tooth and supporting body. Alternatively, the curing of the liner material can cause it to chemically bond to the artificial tooth body and then the subsequent curing of the acrylic forming a supporting body around the liner can cause the supporting body acrylic to chemically bond with the liner material.

The adhesive approach is generally useful for circumstances where the prosthetic tooth is either a porcelain or metal-ceramic reconstruction, but it can be used with an acrylic prosthetic tooth as well. With this approach, if the liner material cannot form a chemical bond with either or both of the prosthetic tooth or supporting body for some reason (referred to herein as an “incompatible” interface or “incompatibility”), an adhesive can be used to glue the liner to the incompatible interface of the prosthetic tooth or supporting body. One example where this may be the case is where the liner is pre-formed on the prosthetic tooth and the post-cured liner material cannot chemically bond with the acrylic of the supporting body. In such a case, an appropriate (e.g., allowed by the U.S. Food and Drug Administration (FDA), or other non-US regulatory administration or body) approved adhesive that is compatible with the liner material and will bond to the supporting body, for example, but not limited to, medical grade adhesives (also called surgical adhesives) such as 2-octyl cyanoacrylate, isobutyl cyanoacrylate, or n-butyl cyanoacrylate, will be applied to some appropriate portion of liner, and then the prosthetic tooth/liner combination will be inserted into a cavity pre-formed within the supporting body.

Likewise, the adhesive approach can be used where the prosthetic tooth is incompatible by, for example, pre-forming the supporting body with a cavity for the tooth and liner, then, using the incompatible tooth material and supporting base as a form for the liner, creating and curing the liner. Then, the incompatible tooth is removed and an adhesive that is compatible with both the liner material and prosthetic tooth can be applied at the liner/prosthetic tooth interface (possibly requiring making room on one or both for the space taken up by the adhesive) and the prosthetic tooth will then be inserted into the cavity formed in the liner by the prosthetic tooth during curing of the liner material.

Alternatively, a mechanical approach can be used. With the mechanical approach, the prosthetic tooth is formed with, or is modified to incorporate, one or more affixation features that allow the liner material to form a physical connection to the prosthetic tooth. Of course, such features can be used to augment and/or add strength when the chemical approach and/or adhesive approach is used to, for example, increase the relevant surface and/or connection area. Suitable features can include, but are not limited to, features such as one or more: holes, posts, lugs, cross bars, recesses or protrusions, as well as any permutations or combinations thereof. It should therefore be understood that, since there are a myriad of potential features that can be used, any feature that allows for a better connection between the liner and prosthetic tooth and does not prevent the liner from displacing and/or shifting as described herein can be used.

As a further matter, in some cases, the supporting base can also incorporate one or more features for similar effect, for example, using one or more of: an overhang, a hole, a recess, or a protrusion, to name a few. In such cases, the feature(s) incorporated into the supporting base can likewise improve the strength of the connection between the liner material and the supporting base.

Thus, one specific representative example process for making a prosthetic tooth, involving a chemical connection between an artificial tooth body and liner, will now be provided. First, an artificial tooth body is selected. Optionally, the artificial tooth body can be modified to incorporate one or more affixation features if not present but desired. Wax is then used to mold the shape of the intended liner on the artificial tooth body of the prosthetic tooth, incorporating the affixation features of the artificial tooth body, if any. The tooth crown is then embedded, or held, for example, in paste, jig or clamp with the wax exposed. Next, a suitable material to be used for the liner mold is applied so as to encapsulate the wax and then hardened. The mold/tooth combination is then heated to melt away the wax. Next, the mold is opened and, in this example, a heat-curable or self-curing liner material, for example, Moloplast-B, is introduced into the area where the wax was. a The mold is then re-closed so that the liner material will be forced to conform to the tooth and mold. The liner material is then cured, or allowed to cure. Next, mold is re-opened and the tooth with the now chemically bonded liner can be removed and, after cleanup to remove any undesired flashing, the prosthetic tooth will be usable in a denture.

According to another specific representative example process involving an artificial tooth body to which the liner will not chemically bond and does not rely upon use of a mechanical connection, the process is the same as just described, except, once the liner has been molded, some of the artificial tooth body, i.e., some portion that will be within the liner, will be removed, for example by grinding, to allow space for an adhesive that will bond to both the cured liner material and artificial tooth body material. Then the adhesive is applied to one or both of the surfaces of artificial tooth body and liner to be bonded. Once the adhesive is set, the prosthetic tooth will be usable in a denture.

The process for forming a denture using a prosthetic tooth, having a liner as described herein, is then the same as would be performed using a conventional prosthetic tooth if the acrylic for the supporting body will chemically bond to the liner material.

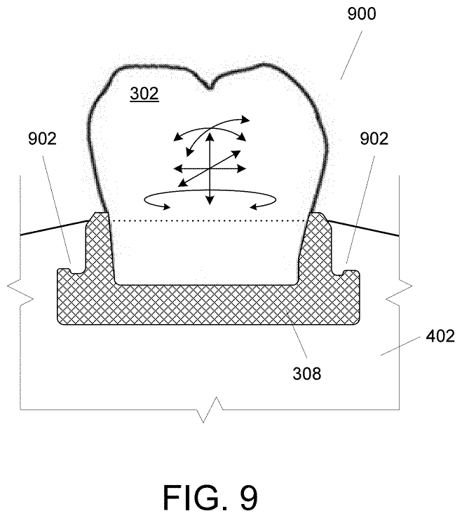

Alternatively, if the acrylic for the supporting body will not chemically bond to the liner material, then either a liner that will form a mechanical connection with the liner must be used, or an affixation feature that is the negative of a locking peripheral shaped liner, for example, a negative of the barrel shaped 308b or flared liners 308c of FIG. 3, the tapered liners 308 of FIGS. 4 through 7, or an over-molded shelf as in FIG. 9. Alternatively, if the peripheral shape of the liner will not itself lock the prosthetic tooth in place, once the supporting body is formed, the prosthetic tooth can be removed from the supporting body, some of the supporting body can be removed to make space for adhesive, i.e., from its periphery within the cavity formed by the liner, and then an adhesive that will bond to both the liner material and supporting body can be inserted in the area from where the material was removed and the prosthetic tooth can then re-inserted to allow the adhesive to bond the liner to the supporting body.

As to all of the foregoing approaches, the important caveat (and significant point of departure from conventional dentures) is that, whatever approach is used, that approach cannot rigidly bond any part of the prosthetic tooth to the supporting base, because some or all of the ability of the tooth to displace, shift, pivot, or twist due to the presence of a liner 308 will be lost.

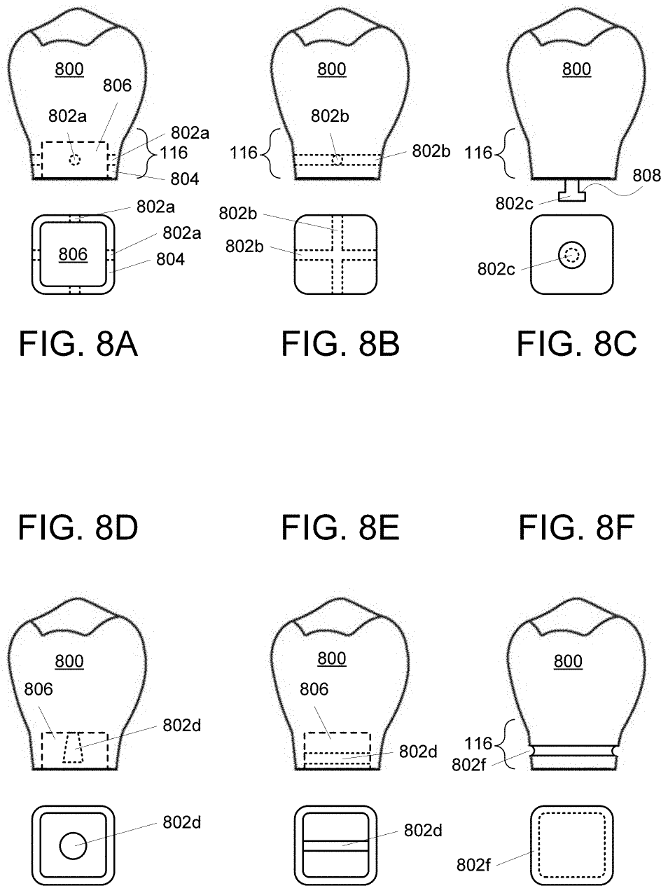

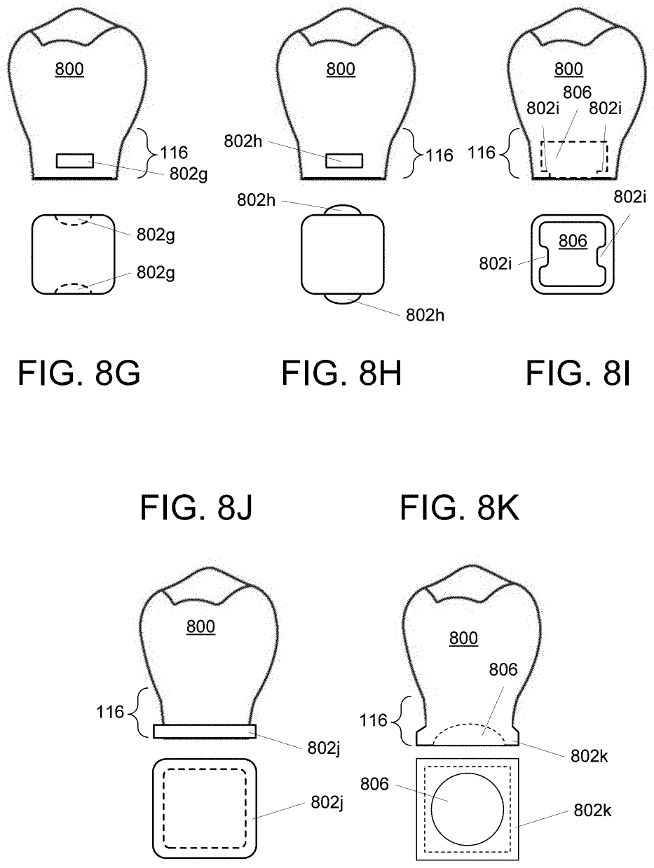

FIGS. 8A through 8K illustrate, in simplified form, lingual and bottom views of example artificial tooth bodies (specifically, a premolar artificial tooth body 800) incorporating one or more example affixation features 802, for purposes such as discussed above. It should be noted however, that these examples are intended to illustrate the advantageous point that numerous affixation features can be used, and is not intended to limit anything described herein to those particular affixation features, their shapes or positioning —any affixation feature that will perform the stated purpose can be used.

More particularly, FIG. 8A illustrates affixation features 802a that are individual holes formed in the wall 804 of a cavity 806 of the tooth neck 116.

FIG. 8B illustrates affixation features 802b that are holes formed in a solid tooth neck 116.

FIG. 8C illustrates an affixation feature in the form of a post or a lug 802c that protrudes outward from the bottom of the neck and includes a step 808 at its bottom.

FIG. 8D illustrates an affixation feature 802d in the form of an alternative post or lug contained within the cavity 806 of the tooth body 800. As shown, this post or lug type affixation feature 802d is “flared” in that it gets progressively wider towards the bottom.

FIG. 8E illustrates an affixation feature 802e in the form of a bar spanning the tooth body cavity 806.

FIG. 8F illustrates an affixation feature 802f in the form of a recess about the periphery of part of the neck 116 of the tooth body 800.

FIG. 8G illustrates affixation features 802g in the form of two recesses formed into part of the neck 116 of the tooth body 800.

FIG. 8H illustrates affixation features 802h in the form of two protrusions extending outward from part of the neck 116 of the tooth body 800.

FIG. 8I illustrates affixation features 802i in the form of two protrusions extending inward within the cavity 806 in the neck 116 of the tooth body 800.

FIG. 8J illustrates an affixation feature 802j in the form of a lip or shelf-type protrusion about the periphery of the bottom of the neck 116 of the tooth body 800.

FIG. 8K illustrates an affixation feature 802k in the form of an alternative lip or shelf-type protrusion about the periphery of the bottom of the neck 116 of a tooth body 800 with an alternative cavity 806.

FIG. 9 illustrates, in simplified form. a cross section 900 of a portion of an example denture incorporating an example of a liner affixation feature 902 formed in the supporting body 402 of a denture. As shown, the affixation feature 902 is an overhang to help constrain the liner 308 that is affixed to the artificial tooth body 302. Notably, the liner affixation feature 902 is located so as to not interfere with displacement or shifting (horizontal, pivotal or twisting) of the artificial tooth body 302.

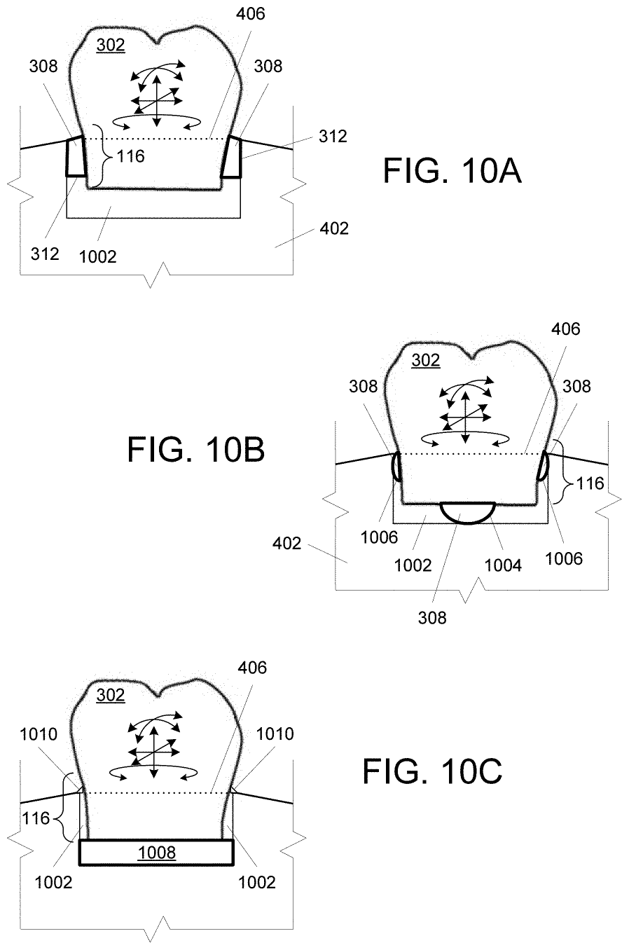

FIGS. 10A through 10C illustrate, in simplified form, some alternative example implementations of my approach that can be used in certain cases.

Specifically, FIG. 10A shows, in simplified form, an alternative implementation that incorporates the part 312 of a liner 308 that is on the sides of the neck 116 because its elastic properties and the geometry of the liner material and geometry of a cavity 1002 formed in the supporting body 402a are such that the maximum movement of the tooth body (both displacement and shift) are within the specified respective normal in vivo tooth displacement/shift ranges.

FIG. 10B shows, in simplified form, an alternative implementation similar to the configuration of FIG. 4, but wherein the liner 308 is made up of two or more discrete, and separate, parts, one of the discrete part(s) 1004 locationally corresponding to the part 310 of the liner 308 of FIG. 4 below the prosthetic tooth's neck 116 and the other discrete part(s) 1006 being the part(s) locationally corresponding to the part 312 of the liner 308 of FIG. 4 alongside the prosthetic tooth neck 116. Note here that, for this implementation, not only are the two parts 310, 312 of FIG. 4 separate from each other, but alternative implementations can have each part 1004, 1006 be made up of separate discrete subcomponent parts (e.g., the part 312 alongside the neck 116 could be made up of three or four (or more) discrete, disconnected, pieces distributed on the buccal/labial side, on the lingual side, and on each proximal side).

FIG. 10C shows, in simplified form, yet another alternative implementation similar to the configuration of FIG. 4, FIG. 10A and FIG. 10B, but, for this implementation, the liner 308 is only made up of a liner part 1008 locationally corresponding to the part 310 of the liner 308 of FIG. 4 that is below the prosthetic tooth's neck 116. With this configuration, that part 1008, in conjunction with the part of the supporting body 402a forming the artificial gum line 406 can establish a limit on the maximum range of displacement and shift, which should again be within the specified respective normal in vivo tooth displacement/shift ranges. Note here, however, that this configuration is far less desirable because foreign matter (like foot particles) can infiltrate into the cavity 1002 and, therefore, implementations using this configuration may require some form of seal 1010 to prevent that infiltration of foreign matter into the cavity 1002 between the artificial tooth body and supporting structure 402a, the type and makeup of the seal 1010, if any, being independent of the present invention.

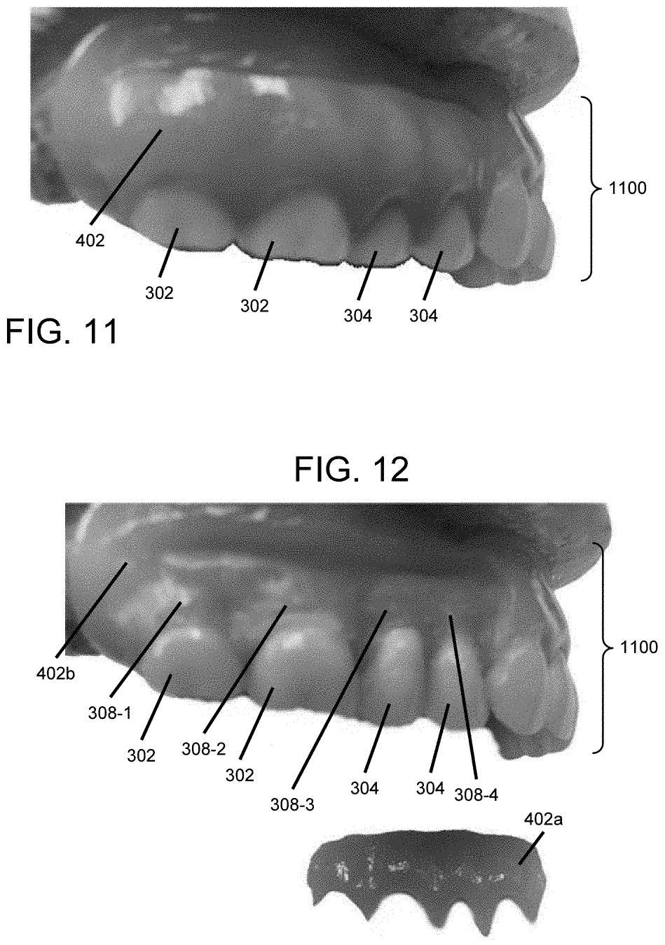

FIG. 11 is a photograph of an example implementation denture 1100 incorporating example variant prosthetic teeth as described herein, specifically prosthetic teeth made up of artificial tooth bodies 302, 304 that include liners 308 (not visible). The liners 308 are affixed to a surrounding supporting body 402 so that the liners 308 can provide for displacement and shifting of those prosthetic teeth within the supporting body 402.

FIG. 12 is a photograph of the example implementation denture 1100 of FIG. 11 in which a section 402a of the supporting body 402b has been removed (cut away) to make visible part of the respective liners 308-1, 308-2, 308-3, 308-4.

Although FIGS. 11-12 show a full denture, it is to be understood that the portion shown as including the teachings herein could also equally be a rigid partial denture that affixes to posts embedded in a patient's bone tissue, or a rigid partial denture that attaches by some other conventional means to other natural teeth, in which case the additional teeth shown in the photograph would be representative of normal teeth.

As a final point, it should be understood that, in order to reasonably replicate periodontal ligament function through use of a liner according to the teachings herein, the maximum movement of the prosthetic tooth should generally be limited to within the normal in vivo tooth displacement range and normal in vivo tooth shift range. However, it is to be understood that there may be times where the maximum values can be below one or both of the normal in vivo tooth displacement range or normal in vivo tooth shift range, for example due to the particular situation of the intended recipient of a particular denture otherwise constructed according to the teachings herein. It is expressly intended that the use of a liner that allows for movement that, at its maximum, is below one or both of the normal in vivo tooth displacement range or normal in vivo tooth shift range, be considered a use of the teachings herein if such values are not required by a particular claim.

Having described and illustrated principles of the invention claimed this application, by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A prosthetic tooth comprising:
an artificial tooth body, and
a deformable liner at least partly coupled to a portion of the artificial tooth body.

2. The prosthetic tooth of claim 1, wherein:
I) the artificial tooth body includes at least
A) a first portion that replicates a tooth crown of a human tooth that is one of a molar, a premolar or a cuspid, and
B) a second portion, adjacent the first portion, that corresponds, in location, to a tooth neck;
II) the liner
A) includes a first section located on a side of the second portion opposite the first portion, and
B) includes a second section coupled to at least some of the second portion of the artificial tooth body, the second section having a varied thickness such that the liner is thinner in an area that is closest to the first portion of the artificial tooth body than in another area that is closer to the first section,
C) comprises an elastically deformable material, and, wherein
i) the first section will compress from an unloaded position, under a first load applied along a tooth long axis of the artificial tooth body, by a first amount that is within a normal in vivo tooth displacement range for a corresponding normal tooth when in situ under the first load along an equivalent normal tooth long axis, and
ii) the second section will at least allow the artificial tooth body to shift from the unloaded position, through deformation of at least some of the liner, under a second load, the second load being applied in a direction that causes at least one of
a) pivoting of the tooth long axis of the artificial tooth body, or
b) translation of the artificial tooth body, perpendicular to the long axis,
such that the shift of the artificial tooth body will be by a second amount that is within a normal in vivo tooth shift range for the corresponding normal tooth when in situ under application of the second load, and
iii) the liner will cause the artificial tooth body to move back towards the unloaded position when at least one of the first lead or second load is reduced.

3. The prosthetic tooth of claim 2, wherein the first section of the liner is between 0.4 mm and 0.6 mm thick.

4. The prosthetic tooth of claim 3, wherein the second section of the liner is between 0.20 mm and 0.35 mm thick in the area that is closest to the first portion.

5. The prosthetic tooth of claim 2, wherein the second section of the liner is between 0.20 mm and 0.35 mm thick in the area that is closest to the first portion.

6. The prosthetic tooth of claim 2, further comprising at least one liner affixation feature that assists in coupling of the liner to the artificial tooth body.

7. The prosthetic tooth of claim 6, wherein the at least one liner affixation feature comprises:
a hole, a post, a lug, a prong, a bar, a recess or a protrusion.

8. The prosthetic tooth of claim 2, wherein at least one of:
a mechanical connection, a chemical connection, or an adhesive material, provides the at least partial coupling of the liner and artificial tooth body.

9. A denture comprising:
I) an acrylic supporting body colored so as to create an appearance of human gum tissue; and
II) at least one prosthetic tooth comprising:
A) an artificial tooth body having at least
i) a first portion that replicates a tooth crown of a human tooth that is one of a molar, a premolar or a cuspid, and
ii) a second portion, adjacent the first portion, that corresponds, in location, to a tooth neck;
B) a liner, substantially within the acrylic supporting body, the liner having a first side and a second side, wherein at least some of the first side is coupled to the artificial tooth body, and at least some of the second side is coupled to the acrylic supporting body, so as to create an appearance of a normal tooth within normal gum tissue, the liner
i) having a first section located on a side of the second portion opposite the first portion, and
ii) having a second section coupled to at least some of the second portion of the tooth body,
iii) wherein the liner comprises an elastically deformable material, and
a) the first section of the liner will compress from an unloaded position within the acrylic supporting body, under a first load applied along a tooth long axis of the artificial tooth body, by a first amount that is within a normal in vivo tooth displacement range for a corresponding normal tooth in situ under the first load along an equivalent normal tooth long axis, and
b) the second section of the liner will allow the tooth body to shift within the acrylic supporting body from the unloaded position, through deformation of at least some of the liner, under a second load, the second load being applied in a direction that causes at least one of
1) pivoting of the long axis, or
2) translation of the artificial tooth body, perpendicular to the long axis,
such that the shift of the tooth body will be by a second amount that is within a normal in vivo tooth shift range for the corresponding normal tooth when in situ under application of the second load, and
c) the liner will cause the artificial tooth body to move back towards the unloaded position when at least one of the first lead or second load is reduced.

10. The denture of claim 9, wherein the first section of the liner is between 0.4 mm and 0.6 mm thick.

11. The denture of claim 10, wherein the second section of the liner is between 0.20 mm and 0.35 mm thick in the area that is closest to the first portion.

12. The denture of claim 10, wherein the second section of the liner is between 0.20 mm and 0.35 mm thick in the area that is closest to the first portion.

13. The denture of claim 9, further comprising at least one liner affixation feature via which the liner is coupled to the artificial tooth body.

14. The denture of claim 13, wherein the at least one liner affixation feature comprises:
a hole, a post, a lug, a prong, a bar, a recess or a protrusion.

15. The denture of claim 9, wherein the acrylic supporting body defines an artificial gum line on the prosthetic tooth and wherein some of the liner extends outside the acrylic supporting body beyond the artificial gum line.

16. The prosthetic tooth of claim 9, wherein the liner is coupled to the artificial tooth body by at least one of:
a mechanical connection, a chemical connection, or an adhesive material.

17. A denture comprising:
a supporting body colored so as to create an appearance of human gum tissue; and
a prosthetic tooth, coupled to the supporting body via an elastically deformable liner, located substantially within the supporting body so as to create an appearance of a normal tooth within normal human gum tissue, the liner having a first side and a second side, wherein a first part of the first side of the liner is coupled to the prosthetic tooth, and a second part of the second side of the liner is coupled to the supporting body so that the prosthetic tooth is only connected to the supporting body via the liner.

18. The denture of claim 17, wherein the liner geometry and elasticity is such that the liner will:
I) compress from an unloaded position within the acrylic supporting body, under a first load applied along a tooth long axis of the prosthetic tooth, by a first amount that is greater than zero but less than an upper limit of a normal in vivo tooth displacement range for a corresponding normal tooth in situ, and
II) allow the prosthetic tooth to shift within the acrylic supporting body from the unloaded position, through deformation of at least some of the liner, under a second load, the second load being applied in a direction that causes at least one of
A) pivoting of the long axis, or
B) translation of the prosthetic tooth, perpendicular to the normal tooth long axis,
such that the shift of the prosthetic tooth will be by a second amount that is greater than zero but less than an upper limit of a normal in vivo tooth shift range for the corresponding normal tooth when in situ, and
III) cause the prosthetic tooth to move back towards the unloaded position when at least one of the first lead or second load is reduced.

19. The denture of claim 18, wherein the first part of the liner is at least partly attached to the prosthetic tooth via at least one liner affixation feature.

20. The denture of claim 19, wherein the at least one liner affixation feature comprises:
a hole, a post, a lug, a prong, a bar, a recess or a protrusion.

21. The denture of claim 18, wherein the acrylic supporting body defines an artificial gum line on the prosthetic tooth and wherein some of the liner extends outside the acrylic supporting body beyond the artificial gum line.

22. The denture of claim 18, wherein the liner is coupled to the artificial tooth body by at least one of:
a mechanical connection, a chemical connection, or an adhesive material.

23. A method of making a prosthetic tooth comprising:
inserting part of an artificial tooth body into a mold, having a cavity therewithin defining a final shape for a liner;
inserting a curable liner material into cavity of the mold so that it contacts at least some of the part of an artificial tooth body, the curable liner material being deformable when cured; and
curing the deformable liner material.

24. The method of claim 23, wherein the curing the deformable liner material bonds the deformable liner material to the artificial tooth body.

25. The method of claim 23, further comprising:
after the curing, adhering the deformable liner material to the artificial tooth body.

26. A method of making a denture comprising:
I) forming a supporting body of a denture about part of a deformable liner;
II) coupling the deformable liner to an artificial tooth body;
wherein steps “I)” and “II)” are performed in one of, in order, in reverse order, or at least partly concurrently, so that after both steps “I)” and “II)” are complete, the artificial tooth body will only be coupled to the supporting body of the denture by the deformable liner, so that artificial tooth body can move relative to the supporting body through deformation of the deformable liner.

27. A method of making a denture comprising:
I) maintaining an artificial tooth body in a spaced relationship with a supporting body for a denture such that the artificial tooth body is positioned where it is to reside in the denture relative to the supporting body and a cavity exists between the artificial tooth body and the supporting body; and
II) introducing a curable material into the cavity that, after curing, the curable material will comprise a liner that
A) couples the artificial tooth body and the supporting body to each other,
B) is deformable such that the artificial tooth body can move relative to the supporting body, through deformation of the liner, due to application of a load of a magnitude that can be applied by a human mouth to the artificial tooth body during at least one of biting or chewing, and such that the artificial tooth body will return towards an undeformed position when the load is removed.

28. The method of claim 27, further comprising:
after the curing, adhering the liner to at least one of the artificial tooth body or the supporting body using a medical grade adhesive.
